(19) United States
(12) Patent Application Publication
(10) Pub. No.: US 2023/0311330 A1
(43) Pub. Date: Oct. 5, 2023

(54) VISUAL HEIGHT ESTIMATOR WITH ROBOTIC POURING CONTROLLER FOR GRANULAR MEDIA

(71) Applicant: SAMSUNG ELECTRONICS CO., LTD., Suwon-si (KR)

(72) Inventors: Alexis BURNS, New York, NY (US); Pedro PIACENZA, Jersey City, NJ (US); Larry JACKEL, Holmdel, NJ (US); Shurna SONG, New York, NY (US); Daewon LEE, Princeton, NJ (US)

(73) Assignee: SAMSUNG ELECTRONICS CO., LTD., Suwon-si (KR)

(21) Appl. No.: 18/127,789

(22) Filed: Mar. 29, 2023

Related U.S. Application Data
(60) Provisional application No. 63/325,086, filed on Mar. 29, 2022.

(51) Int. Cl. B25J 9/16; B67D 3/00

(52) U.S. Cl. CPC B25J 9/1697; B25J 9/1679; B67D 3/0051

(57) ABSTRACT

Provided are a robotic device and a method for controlling a robotic device for pouring a granular media including obtaining an image of a receiving container, identifying, using the image and a convolutional neural network, a current height of granular media in the receiving container, identifying a terminal height of the granular media in the receiving container, determining an input trajectory signal to the robotic device for pouring a non-granular media to the terminal height of the granular media based on the current height of the granular media, determining a wrist tilt command signal by modifying the input trajectory signal using a square wave that is based on a type of the granular media, and controlling the robotic device to tilt and vibrate a source container according to the wrist tilt command signal.

### CROSS-REFERENCE TO RELATED APPLICATION

This application is based on and claims priority under 35 U.S.C. § 119 from U.S. Provisional Application No. 63/325,086 filed on Mar. 29, 2022, in the U.S. Patent & Trademark Office, the disclosure of which is incorporated by reference herein in its entirety.

### BACKGROUND

### 1. Field

The disclosure relates to a robotic device and a method for controlling a robotic device for pouring a granular media, by processing an image of a receiving container.

### 2. Description of Related Art

Due to technological advancements in robotics related to performing tasks, e.g., kitchen tasks, a use for controlled pouring has increased, as pouring is a common task completed in the kitchen. While robotic pouring has been implemented in an industrial setting, this has been accomplished using a robot customized to perform that task in an environment that is also specific to that task. For a robot to maneuver in a common kitchen, it is useful for it to perform a variety of manipulation tasks in the kitchen. Therefore, use of a more diversified robotic system with multiple manipulation capabilities may be useful. Robotic pouring is a difficult task because the dynamics of both liquid and granular media (e.g., coffee beans, pinto beans, dry rice, cereal) are difficult to model. For a pouring task, a non-viscous liquid may flow continually, forming an even surface in the receiving container. However, granular media may have an inconsistent flow due to particles building up on each other, a phenomenon often referred to as jamming. Granular media also does not form a uniform surface. Both of these characteristics of granular media change the potential usage of tactile, vision, or audio sensors to estimate pouring metrics. Pouring granular media may be a difficult task that requires both estimation and control.

### SUMMARY

Provided are a robotic device and a method for controlling a robotic device for pouring a granular media using an image of a receiving container.

Additional aspects will be set forth in part in the description which follows and, in part, will be apparent from the description, or may be learned by practice of the presented embodiments.

In accordance with an aspect of the disclosure, there is provided a method for controlling a robotic device for pouring a granular media, the method including: obtaining an image of a receiving container; identifying, using the image and a convolutional neural network, a current height of granular media in the receiving container; identifying a terminal height of the granular media in the receiving container; determining an input trajectory signal to the robotic device for pouring a non-granular media to the terminal height of the granular media based on the current height of the granular media; determining a wrist tilt command signal by modifying the input trajectory signal using a square wave that is based on a type of the granular media; and controlling the robotic device to tilt and vibrate a source container according to the wrist tilt command signal.

The method may include, while controlling the robotic device to tilt and vibrate the source container, identifying the current height of the granular media in the receiving container at predetermined time intervals.

The method may include modifying the wrist tilt command signal based on the identified current height of the granular media in the receiving container at each predetermined time interval.

The modifying the wrist tilt command signal may include modifying the wrist tilt command signal using a proportional-derivative (PD) controller.

The method may include receiving a user input to the robotic device for identifying the type of the granular media.

The user input may be a voice command.

The obtaining the image may include obtaining the image using a camera connected to the robotic device.

The image may be an RGB image.

In accordance with an aspect of the disclosure, there is provided a robotic device including: at least memory storing instructions; and at least one processor configured to execute the instructions to: obtain an image of a receiving container; identify, using the image and a convolutional neural network, a current height of granular media in the receiving container; identify a terminal height of the granular media in the receiving container; determine an input trajectory signal to the robotic device for pouring a non-granular media to the terminal height of the granular media based on the current height of the granular media; determine a wrist tilt command signal by modifying the input trajectory signal using a square wave that is based on a type of the granular media; and control the robotic device to tilt and vibrate a source container according to the wrist tilt command signal.

The at least one processor may be further configured to execute the instructions to: while controlling the robotic device to tilt and vibrate the source container, identify the current height of the granular media in the receiving container at predetermined time intervals.

The at least one processor may be further configured to execute the instructions to modify the wrist tilt command signal based on the identified current height of the granular media in the receiving container at each predetermined time interval.

The at least one processor may be further configured to modify the wrist tilt command signal may include modifying the wrist tilt command signal using a proportional-derivative (PD) controller.

The at least one processor may be further configured to execute the instructions to receive a user input to the robotic device for identifying the type of the granular media.

The user input is a voice command.

The at least one processor may be further configured to execute the instructions to obtain the image using a camera connected to the robotic device.

The image may be an RGB image.

In accordance with an aspect of the disclosure, there is provided a non-transitory computer readable storage medium that stores instructions to be executed by at least one processor to perform a method for controlling a robotic device for pouring a granular media, the method including: obtaining an image of a receiving container; identifying, using the image and a convolutional neural network, a current height of granular media in the receiving container; identifying a terminal height of the granular media in the receiving container; determining an input trajectory signal to the robotic device for pouring a non-granular media to the terminal height of the granular media based on the current height of the granular media; determining a wrist tilt command signal by modifying the input trajectory signal using a square wave that is based on a type of the granular media; and controlling the robotic device to tilt and vibrate a source container according to the wrist tilt command signal.

The method may include, while controlling the robotic device to tilt and vibrate the source container, identifying the current height of the granular media in the receiving container at predetermined time intervals.

The method may include modifying the wrist tilt command signal based on the identified current height of the granular media in the receiving container at each predetermined time interval.

The method may include modifying the wrist tilt command signal using a proportional-derivative (PD) controller.

### BRIEF DESCRIPTION OF THE DRAWINGS

The above and other aspects, features, and advantages of embodiments of the disclosure will be more apparent from the following description taken in conjunction with the accompanying drawings, in which:

FIG. 1 is a block diagram illustrating a process of estimating a granular media height and providing a wrist tilt command to a robotic element, according to an embodiment;

FIG. 2 is a block diagram illustrating a process of providing a wrist tilt command that is modified for granular media, according to an embodiment;

FIG. 3 is a block diagram illustrating a reactive controller that modifies a wrist tilt command based on changes in a poured height, according to an embodiment;

FIG. 4 is a flowchart illustrating an example process of estimating a granular media height and providing a wrist tilt command to a robotic element, according to an embodiment; and

FIG. 5 is a flowchart illustrating an example process of estimating a granular media height and providing a wrist tilt command to a robotic element, according to an embodiment.

### DETAILED DESCRIPTION

Embodiments of the present disclosure provide a robotic device and a method for controlling a robotic device for pouring a granular media using an image of a receiving container.

As the disclosure allows for various changes and numerous examples, one or more embodiments will be illustrated in the drawings and described in detail in the written description. However, this is not intended to limit the disclosure to modes of practice, and it will be understood that all changes, equivalents, and substitutes that do not depart from the spirit and technical scope of the disclosure are encompassed in the disclosure.

In the description of the embodiments, detailed explanations of related art are omitted when it is deemed that they may unnecessarily obscure the essence of the disclosure. Also, numbers (for example, a first, a second, and the like) used in the description of the specification are identifier codes for distinguishing one element from another.

Also, in the present specification, it will be understood that when elements are “connected” or “coupled” to each other, the elements may be directly connected or coupled to each other, but may alternatively be connected or coupled to each other with an intervening element therebetween, unless specified otherwise.

In the present specification, regarding an element represented as a “unit” or a “module,” two or more elements may be combined into one element or one element may be divided into two or more elements according to subdivided functions. In addition, each element described hereinafter may additionally perform some or all of functions performed by another element, in addition to main functions of itself, and some of the main functions of each element may be performed entirely by another component.

Throughout the disclosure, the expression “at least one of a, b or c” indicates only a, only b, only c, both a and b, both a and c, both b and c, all of a, b, and c, or variations thereof.

Embodiments may relate to a granular media pouring capability in both home and restaurant kitchens and dining areas. When pouring any granular media, e.g., beans, rice, coffee, etc., an appropriate amount of beans or rice may need to be poured into the pot or rice cooker prior to cooking. When storing food in a pantry, canisters are often used to store granular media. Pouring into and out of these canisters is a common occurrence.

Embodiments may provide a neural network that estimates a granular media height within an average of 2 mm accuracy using a single image of a receiving container. Embodiments may include a convolutional neural network (CNN) followed by two fully connected layers to encode the image information and learn weights specific to changing granular media height.

Embodiments may provide a vibrating pouring controller that intakes a desired height trajectory and modulates the signal by adding a square wave. This may vibrate the wrist joint while also following the pouring trajectory, causing the granular media to pour in a more fluid like manner, increasing the accuracy of height estimation.

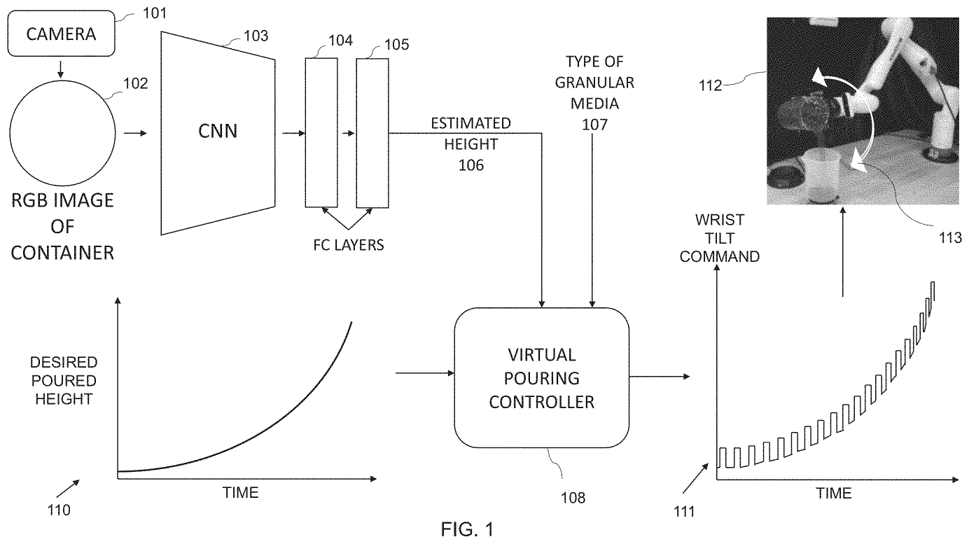

FIG. 1 is a block diagram illustrating a process of estimating a granular media height and providing a wrist tilt command to a robotic element, according to an embodiment. According to an embodiment, a camera 101 captures and/or obtains a top-view RGB image 102 of a container. Embodiments are not limited to an RGB image. For example, the image may be a depth image and/or an RGB depth image. The captured RGB image 102 is input into a convolutional neural network (CNN) 103.

According to an embodiment, the CNN 103 receives the RGB image 102 as an input, and outputs embedding vectors to be converted into an estimated granular media height via fully connected (FC) layers 104 and 105. The CNN 103 may be trained by reducing or minimizing a loss between the estimated granular media height and a ground truth media height. To provide a robust CNN 103, the training of the CNN 103 is performed on images including granular media in many types of situations. For example, the CNN 103 is trained using images in which a granular media has shifted in the container, images in which the height is uneven, etc. Additionally, the CNN 103 is trained using a variety of types of granular media and a variety of receiving containers. For example, the training data may include images including different types of receiving containers that may have different sizes, shapes, heights, and angled surfaces. Thus, a height may be estimated for any type of container.

According to an embodiment, the output from the CNN 103 is provided to the fully connected (FC) layers 104 and 105. The FC layers receive the output from the CNN 103 and reduce the complexity of the image to a single value for an estimated height of the granular media. Thus, based on the output from the two FC layers 104 and 105, an estimated height 106 is determined. The estimated height 106 is provided as an input to a vibrating pouring controller 108. Also, a type of granular media 107 (e.g., coffee beans, pinto beans, dry rice, cereal) is input to the vibrating pouring controller 108. An additional input to the vibrating pouring controller 108 is an input waveform 110, which is based on a desired poured height vs. time for a non-granular media, e.g., liquid, are input to a vibrating pouring controller 108.

According to an embodiment, the neural network 103 may estimate granular media height within an average of 2 mm accuracy using a single image of the receiving container.

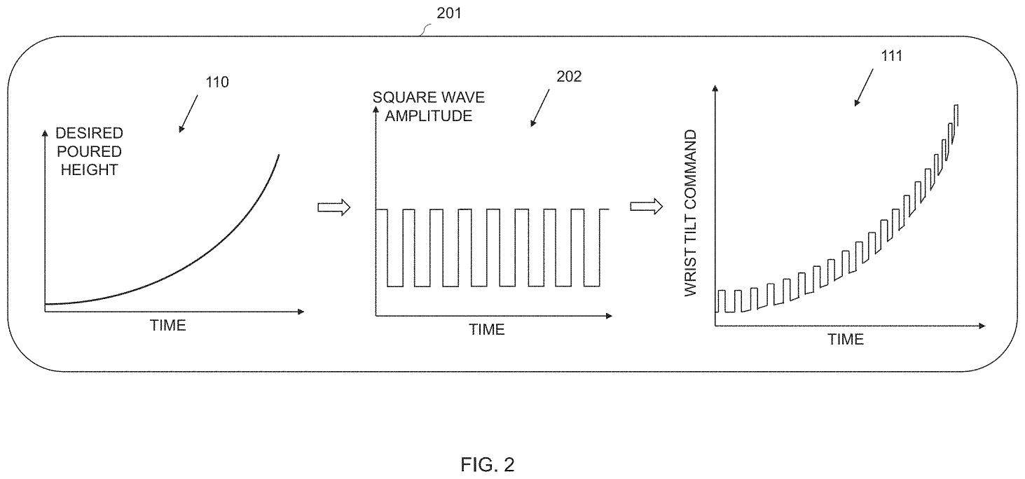

According to an embodiment, the vibrating pouring controller receives the estimated height 106, type of granular media 107, and input waveform 110, and generates an output waveform 111. The output waveform is a modified square wave, and is described in more detail below with respect to FIG. 2. The output waveform 111 is provided to the robotic element 112, and the output waveform is used to control the tilt and vibration of the robotic element, as illustrated by arrows 113 indicating the tilting of the robotic element. For example, an integer value may be provided to the robotic element identifying an angle of the wrist element of the robotic element.

In addition to using an estimated height of the granular media, a density of the granular media may also be used as an input to the vibrating pouring controller.

According to an embodiment, a lookup table may be used to determine a value to be provided as the density.

TABLE 1

| Type of Media | Density (kg/m³) |
|---|---|
| coffee beans | 314 |
| pinto beans | 785 |
| dry rice, | 845 |
| cereal | 122 |

FIG. 2 is a block diagram illustrating a process of estimating a granular media height and providing a wrist tilt command that is modified for granular media to a vibrating pouring controller 201, according to an embodiment. As illustrated in FIG. 2, according to an embodiment, the input waveform 110 is modulated by a square wave 202, resulting in waveform 111, which may be a modulated square wave to vibrate granular media while pouring the granular media to reach the desired height.

According to an embodiment, the input waveform 110 provides a smooth wrist-tilt trajectory beginning at a starting height and proceeding to a desired height. The trajectory of input waveform 110 is similar to pouring with a non-granular media, e.g., liquid.

According to an embodiment, the input waveform 110 may be modulated by a square waveform 202. The square waveform has a frequency and amplitude selected based on the type of granular media. For example, the larger and denser the media, the larger the amplitude of the square waveform. However, embodiments are not limited to this.

According to an embodiment, the waveform 111 is provided to the controller for the wrist of the robotic element to control how much to tilt the wrist based on the feedback received. For example, according to an embodiment, the feedback is the estimated height of the granular media in the receiving container. The estimated height of the granular media in the receiving container is being continuously monitored to confirm whether the waveform 111 is being followed. Based on the determination of whether waveform 111 is being followed, the wrist of the robotic element may be tilted more or less.

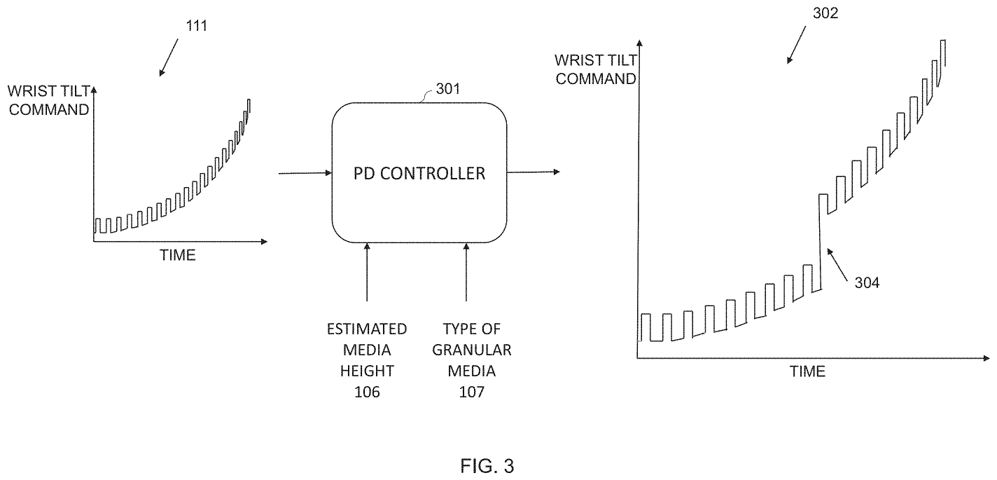

FIG. 3 is a block diagram illustrating a reactive controller that modifies a wrist tilt command based on changes in a poured height, according to an embodiment. As illustrated in FIG. 3, according to an embodiment, the waveform 111 is provided to a proportional-derivative (PD) controller 301. Using, the estimated media height 106, the type of granular media 107, and the waveform 111, the PD controller generates a modified waveform 302, which is provided to the wrist of the robotic element for controlling the wrist angle.

According to an embodiment, the PD controller 301 continuously monitors the current estimated height of the granular media 106, and compares the current estimated height with the desired height, and adjusts the wrist trajectory to provide the appropriate height of the granular media. For example, the PD controller may check the height of the granular media every 10 ms, but embodiments are not limited to this. Based on the estimated height of the granular media 106 and the type of the granular media 107, the PD controller 301 determines whether to adjust the wrist tilt angle of the robotic element. For example, as illustrated at section 304 of the modified waveform 304, the waveform 302 may include a section 304 that increases vibration if the height is not increasing according to the waveform 111. This may occur if the granular media gets stuck in the container.

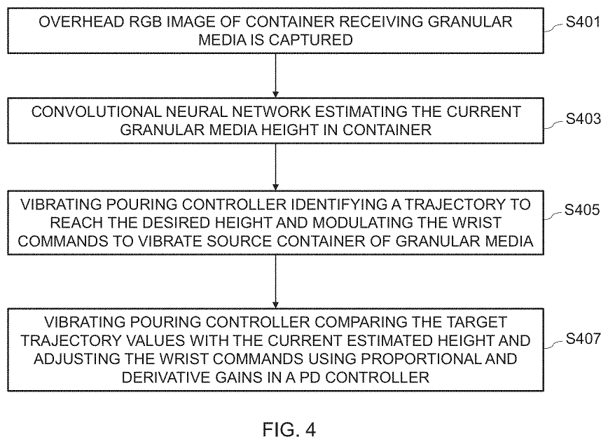

FIG. 4 is a flowchart illustrating an example process of estimating a granular media height and providing a wrist tilt command to a robotic element, according to an embodiment. In operation S401, the process may include obtaining an overhead RGB image of a container receiving granular media. For example, a camera may obtain a top-view RGB image of the container.

In operation S403, the process may include using a convolutional neural network (CNN) to estimate the current granular media height in container. For example, according to an embodiment, the CNN receives the RGB image as an input, and outputs embedding vectors to be converted into an estimated granular media height via fully connected (FC) layers. The CNN may be trained by reducing or minimizing a loss between the estimated granular media height and a ground truth media height. To provide a robust CNN, the training of the CNN is performed on images including granular media in many types of situations. For example, the CNN is trained using images in which a granular media has shifted in the container, images in which the height is uneven, etc. Additionally, the CNN is trained using a variety of types of granular media and a variety of receiving containers. For example, the training data may include images including different types of receiving containers that may have different sizes, shapes, heights, and angled surfaces. Thus, a height may be estimated for any type of container. According to an embodiment, the output from the CNN is provided to the fully connected (FC) layers. The FC layers receive the output from the CNN and reduce the complexity of the image to a single value for an estimated height of the granular media. Thus, based on the output from the two FC layers, an estimated height 106 is determined. The estimated height is provided as an input to a vibrating pouring controller . Also, a type of granular media (e.g., coffee beans, pinto beans, dry rice, cereal) is input to the vibrating pouring controller. An additional input to the vibrating pouring controller 108 is an input waveform, which is based on a desired poured height vs. time for a non-granular media, e.g., liquid, are input to a vibrating pouring controller.

In operation S405, the process may include vibrating a pouring controller to identify a trajectory to reach the desired height and modulating the wrist commands to vibrate a source container of granular media. For example, an input waveform is modulated by a square wave, resulting in a modulated square waveform to control a wrist of a robotic element to vibrate granular media while pouring the granular media to reach the desired height.

In operation S407, the process may include a vibrating pouring controller comparing the target trajectory values with the current estimated height and may adjust the wrist commands using proportional and derivative gains in a PD controller. For example, according to an embodiment, the derivative gains may determine an amount of difference between an estimated height of the granular media and a desired height of the granular media.

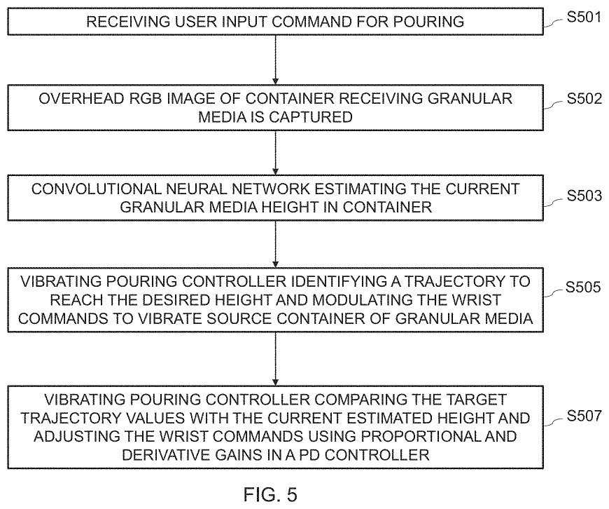

FIG. 5 is a flowchart illustrating an example process of estimating a granular media height and providing a wrist tilt command to a robotic element, according to an embodiment. In operation S501, the process may include receiving a user input command for pouring. For example, a user may utter a spoken command to tell the robot to fill up a coffee grinder, e.g., “Hey Bixby, fill up the coffee grinder.” A user input command may also be received using an input device, such as a remote control or an electronic device, e.g., a mobile device.

In operation S502, the process may include obtaining an overhead RGB image of a container receiving granular media. For example, a camera may obtain a top-view RGB image of the container.

In operation S503, the process may include using a convolutional neural network (CNN) to estimate the current granular media height in container. For example, according to an embodiment, the CNN receives the RGB image as an input, and outputs embedding vectors to be converted into an estimated granular media height via fully connected (FC) layers. The CNN may be trained by reducing or minimizing a loss between the estimated granular media height and a ground truth media height. To provide a robust CNN, the training of the CNN is performed on images including granular media in many types of situations. For example, the CNN is trained using images in which a granular media has shifted in the container, images in which the height is uneven, etc. Additionally, the CNN is trained using a variety of types of granular media and a variety of receiving containers. For example, the training data may include images including different types of receiving containers that may have different sizes, shapes, heights, and angled surfaces. Thus, a height may be estimated for any type of container. According to an embodiment, the output from the CNN is provided to the fully connected (FC) layers. The FC layers receive the output from the CNN and reduce the complexity of the image to a single value for an estimated height of the granular media. Thus, based on the output from the two FC layers, an estimated height 106 is determined. The estimated height is provided as an input to a vibrating pouring controller. Also, a type of granular media (e.g., coffee beans, pinto beans, dry rice, cereal) is input to the vibrating pouring controller. An additional input to the vibrating pouring controller 108 is an input waveform, which is based on a desired poured height vs. time for a non-granular media, e.g., liquid, are input to a vibrating pouring controller.

In operation S505, the process may include vibrating a pouring controller to identify a trajectory to reach the desired height and modulating the wrist commands to vibrate a source container of granular media. For example, an input waveform is modulated by a square wave, resulting in a modulated square waveform to control a wrist of a robotic element to vibrate granular media while pouring the granular media to reach the desired height.

In operation S507, the process may include a vibrating pouring controller comparing the target trajectory values with the current estimated height and may adjust the wrist commands using proportional and derivative gains in a PD controller. For example, according to an embodiment, the derivative gains may determine an amount of difference between an estimated height of the granular media and a desired height of the granular media.

According to one or more embodiments, a neural network may estimate granular media height within an average of 2 mm accuracy using a single image of the receiving container.

According to one or more embodiments, a vibrating pouring controller intakes a desired height trajectory and modulates the signal by adding a square wave. This vibrates the wrist joint while also following the pouring trajectory, causing the granular media to pour in a more fluid like manner, increasing the accuracy of height estimation.

While the embodiments of the disclosure have been described with reference to the figures, it will be understood by those of ordinary skill in the art that various changes in form and details may be made therein without departing from the spirit and scope as defined by the following claims.

What is claimed is:

1. A method for controlling a robotic device for pouring a granular media, the method comprising:
obtaining an image of a receiving container;
identifying, using the image and a convolutional neural network, a current height of granular media in the receiving container;
identifying a terminal height of the granular media in the receiving container;
determining an input trajectory signal to the robotic device for pouring a non-granular media to the terminal height of the granular media based on the current height of the granular media;
determining a wrist tilt command signal by modifying the input trajectory signal using a square wave that is based on a type of the granular media; and
controlling the robotic device to tilt and vibrate a source container according to the wrist tilt command signal.

2. The method of claim 1, further comprising:
while controlling the robotic device to tilt and vibrate the source container, identifying the current height of the granular media in the receiving container at predetermined time intervals.

3. The method of claim 2, further comprising modifying the wrist tilt command signal based on the identified current height of the granular media in the receiving container at each predetermined time interval.

4. The method of claim 3, wherein the modifying the wrist tilt command signal comprises modifying the wrist tilt command signal using a proportional-derivative (PD) controller.

5. The method of claim 1, further comprising receiving a user input to the robotic device for identifying the type of the granular media.

6. The method of claim 5, wherein the user input is a voice command.

7. The method of claim 1, wherein obtaining the image comprises obtaining the image using a camera connected to the robotic device.

8. The method of claim 1, wherein the image is an RGB image.

9. A robotic device comprising:
at least memory storing instructions; and
at least one processor configured to execute the instructions to:
obtain an image of a receiving container;
identify, using the image and a convolutional neural network, a current height of granular media in the receiving container;
identify a terminal height of the granular media in the receiving container;
determine an input trajectory signal to the robotic device for pouring a non-granular media to the terminal height of the granular media based on the current height of the granular media;
determine a wrist tilt command signal by modifying the input trajectory signal using a square wave that is based on a type of the granular media; and
control the robotic device to tilt and vibrate a source container according to the wrist tilt command signal.

10. The robotic device of claim 9, wherein the at least one processor is further configured to execute the instructions to:
while controlling the robotic device to tilt and vibrate the source container, identify the current height of the granular media in the receiving container at predetermined time intervals.

11. The robotic device of claim 10, wherein the at least one processor is further configured to execute the instructions to modify the wrist tilt command signal based on the identified current height of the granular media in the receiving container at each predetermined time interval.

12. The robotic device of claim 11, wherein the at least one processor is further configured to modify the wrist tilt command signal comprises modifying the wrist tilt command signal using a proportional-derivative (PD) controller.

13. The robotic device of claim 9, wherein the at least one processor is further configured to execute the instructions to receive a user input to the robotic device for identifying the type of the granular media.

14. The robotic device of claim 13, wherein the user input is a voice command.

15. The robotic device of claim 9, wherein the at least one processor is further configured to execute the instructions to obtain the image using a camera connected to the robotic device.

16. The robotic device of claim 9, wherein the image is an RGB image.

17. A non-transitory computer readable storage medium that stores instructions to be executed by at least one processor to perform a method for controlling a robotic device for pouring a granular media, the method comprising:
obtaining an image of a receiving container;
identifying, using the image and a convolutional neural network, a current height of granular media in the receiving container;
identifying a terminal height of the granular media in the receiving container;
determining an input trajectory signal to the robotic device for pouring a non-granular media to the terminal height of the granular media based on the current height of the granular media;
determining a wrist tilt command signal by modifying the input trajectory signal using a square wave that is based on a type of the granular media; and
controlling the robotic device to tilt and vibrate a source container according to the wrist tilt command signal.

18. The non-transitory computer readable storage medium of claim 17, further comprising:
while controlling the robotic device to tilt and vibrate the source container, identifying the current height of the granular media in the receiving container at predetermined time intervals.

19. The non-transitory computer readable storage medium of claim 18, further comprising modifying the wrist tilt command signal based on the identified current height of the granular media in the receiving container at each predetermined time interval.

20. The non-transitory computer readable storage medium of claim 19, wherein the modifying the wrist tilt command signal comprises modifying the wrist tilt command signal using a proportional-derivative (PD) controller.
